(19) United States
(12) Patent Application Publication
(10) Pub. No.: US 2006/0037420 A1
(43) Pub. Date: Feb. 23, 2006

(54) Mechanical actuator and speed changer combination

(75) Inventors: Daniel Alva Mast JR., Fort Mill, SC (US); Michael G. Miller, Charlotte, NC (US)

Correspondence Address: KENNEDY COVINGTON LOBDELL & HICKMAN, LLP, 214 N. TRYON STREET, HEARST TOWER, 47TH FLOOR, CHARLOTTE, NC, 28202, US

(73) Assignee: Yale Industrial Products, Inc., Amherst, NY (US)

(21) Appl. No.: 10/924,298

(22) Filed: Aug. 23, 2004

(51) Int. Cl. F16H 25/20

(52) U.S. Cl. 74/89.14; 74/89.23

(57) ABSTRACT

In combination, a mechanical actuator and a speed changer coupled directly to one another. The mechanical actuator comprises an actuator housing, an actuator output shaft supported within the actuator housing for linear reciprocation inwardly and outwardly therefrom, an actuator input shaft supported rotationally within the actuator housing with an end of the actuator input shaft projecting outwardly from the actuator housing, and a mechanical arrangement within the actuator housing for translating rotational motion of the actuator input shaft into linear motion of the actuator output shaft. The speed changer comprises a changer housing having an output flange abutted with and affixed directly to the actuator housing in surrounding relation to the actuator input shaft and a changer output shaft supported rotationally within the output flange. The changer output shaft is formed with a blind hole for receiving the actuator input shaft.

### FIELD OF THE INVENTION

The present invention relates generally to mechanical actuators and, more particularly, to motor driven mechanical actuators wherein a speed changer unit, such as a speed reducer or other torque multiplier, is connected between the motor drive and the mechanical actuator.

### BACKGROUND OF THE INVENTION

Mechanical actuators have long been known and utilized in various industry applications, such as for the controlled lifting, adjusting, opening/closing and similar actuation of precision movements of industry equipment and components thereof. Typically, such mechanical actuators are in the form of a linear actuator unit basically having an actuator output shaft linearly reciprocal within a housing via an appropriate drive mechanism, such as a worm drive mechanism, actuated by an input shaft. Depending upon the application, such mechanical actuators may be operated manually or may be motorized via an air, hydraulic or electric drive motor connected to the input shaft of the actuator.

In some applications, it may also be necessary or desirable to provide a speed change unit, such as a speed reducer or other torque multiplier, between the motor drive and the mechanical actuator to appropriately modify the drive ratio between the motor and the mechanical actuator. While mechanical actuators and speed change units are conventionally available from differing manufacturers, these devices are not designed and engineered to mate with one another, whereby it is conventionally necessary to make structural modifications to both the actuator and the speed change unit to facilitate direct mounting to one another. For example, to adapt a worm-driven linear mechanical actuator to be coupled with a speed reducer unit, it is conventionally necessary to replace the worm shaft with a more elongated worm shaft and to provide an enlarged flange on the actuator housing and, in turn, the output shaft assembly of the speed reducer must be modified to connect integrally with the input worm shaft of the actuator.

### SUMMARY OF THE INVENTION

It is accordingly an object of the present invention to simplify the modifications necessary to equip a mechanical actuator with a speed changer unit. A more particular object of the present invention is to provide an improved form of speed changer unit particularly adapted to mount directly to a conventional mechanical actuator so that structural modifications to the mechanical actuator are unnecessary, whereby such actuator can be utilized essentially “off the shelf.”

Briefly summarized, the present invention addresses these objectives by providing an improved speed changer unit adapted particularly for combination with a conventional mechanical actuator. More particularly, the mechanical actuator is preferably of the conventional type basically having an actuator housing, an actuator output shaft supported within the actuator housing for linear reciprocation inwardly and outwardly therefrom, an actuator input shaft supported rotatably within the actuator housing with an end of the actuator input shaft projecting outwardly from the actuator housing, and a mechanical arrangement, e.g., a worm drive arrangement, within the actuator housing for translating the rotational movement of the actuator input shaft into linear motion of the actuator output shaft. In accordance with the present invention, the speed changer unit basically comprises a changer housing having an output flange adapted to be abutted with and affixed directly to the actuator housing in surrounding relation to the actuator input shaft, and a changer output shaft supported rotationally within the output flange to mate with the actuator input shaft. For this purpose, the changer output shaft is formed with a blind hold in which the actuator input shaft is received. In this manner, the changer housing and actuator housing are rigidly connected with one another and the changer output shaft and the actuator input shaft are integrally connected for driving rotation of the actuator input shaft by the changer output shaft.

In the preferred embodiment of the invention, the worm drive arrangement of the mechanical actuator comprises a work gear coaxial with the actuator output shaft and a meshing worm coaxial with the actuator input shaft. In most embodiments, the speed changer would preferably be a speed reducer or a like torque multiplier. Preferably, either the actuator input shaft or the changer output shaft is formed with an integral key, while the other is formed with a mating keyway for receiving the key.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view, partially cut away, depicting a prior art combination of a mechanical actuator and a speed changer wherein each unit is modified to adapt for mounting to one another;

FIG. 2 is an exploded perspective view of a conventional mechanical actuator unit including the additional parts required for combining it with a conventional speed changer unit;

FIG. 3 is an exploded perspective view of a conventional speed changer unit;

FIG. 4 is a view partially cut-away comparable to FIG. 1, depicting a preferred embodiment of the present invention wherein an improved speed changer unit according to the present invention is coupled with a substantially unmodified conventional mechanical actuator;

FIG. 5 is an exploded perspective view of the improved speed changer unit of the present invention; and

FIG. 6 is a perspective view of the coupled mechanical actuator unit and improved speed changer unit in use.

### DETAILED DESCRIPTION OF THE PREFERRED EMBODIMENT

The following description of the preferred embodiment(s) is merely exemplary in nature and is in no way intended to limit the invention, its application, or uses.

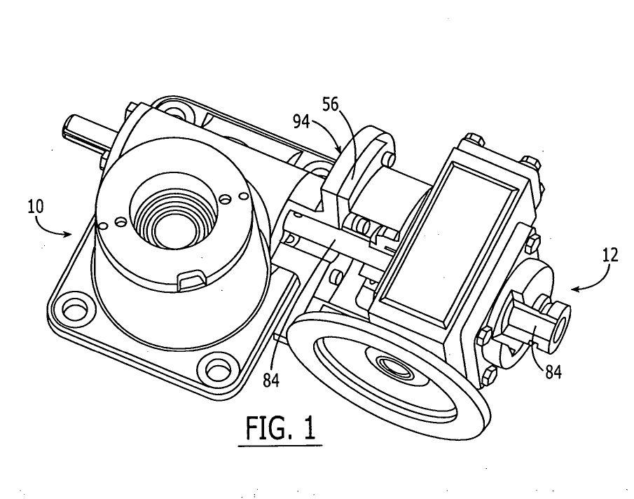

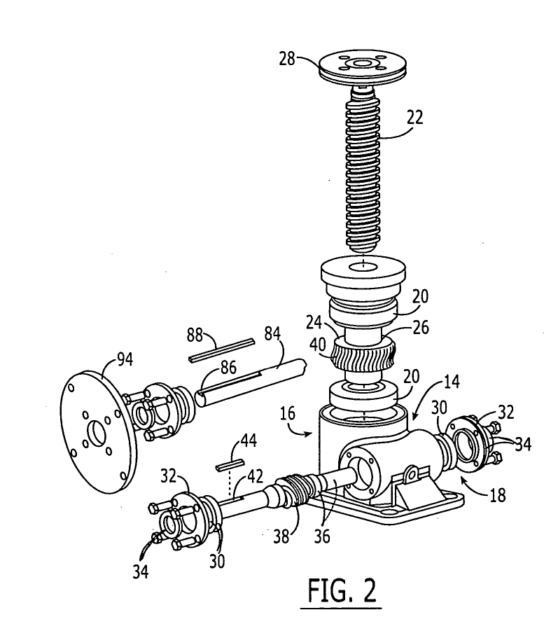

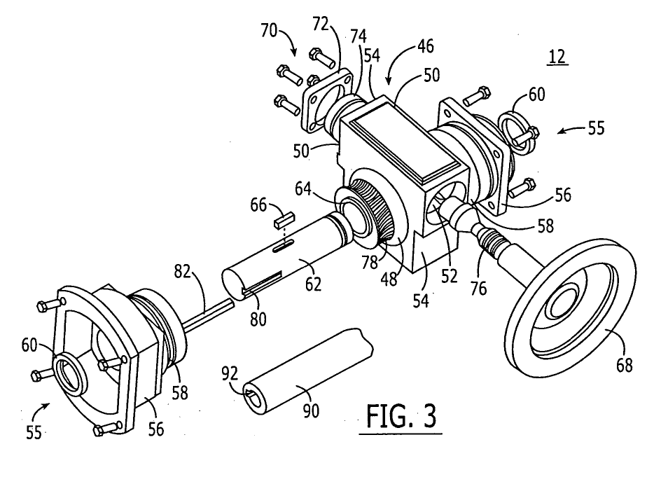

Referring now to the accompanying drawings, in which like numerals represent like components throughout the several views, and with initial references to FIGS. 1-3, a conventional prior art combination of a modified conventional mechanical actuator unit, indicated generally at 10, and a modified conventional speed changer unit, indicated generally at 12, is shown in partially cut-away perspective in FIG. 1. FIG. 2 is an exploded perspective view of the unmodified conventional mechanical actuator unit 10, including the additional replacement components required to modify the actuator unit 10 for combination with the modified speed changer unit 12. FIG. 3 is an exploded perspective view of the conventional unmodified speed changer unit 12, including the additional replacement components required to modify the speed changer unit 12 for combination with the modified mechanical actuator unit 10.

As shown in FIG. 2, the mechanical actuator unit 10 conventionally includes an actuator housing 14 having two cylindrical housing shells, 16, 18, welded or otherwise affixed together in axially perpendicular relationship and defining respective interior areas opening to one another within which the shell 16 encloses output components and the shell 18 encloses input components of the actuator unit 10. The actuator housing shell 16 is fitted at its opposite ends with two coaxially spaced annular load bearings 20 which centrally receive and support coaxially a threaded lifting screw 22 for axial reciprocation inwardly and outwardly relative to the housing shell 16. An interiorly and exteriorly threaded annular worm gear 24 is rotationally supported between and coaxial with the spaced load bearings 20 with the interior threads 26 of the worm gear 24 in meshing engagement with the threaded lifting screw 22, thereby to drive the reciprocal movement thereof. The threaded lifting screw may have a top plate 28, a threaded end (not shown) or a clevis end (not shown) for attachment to a driven member, depending on the application of the mechanical actuator unit 10.

The housing shell 18 similarly supports at its opposite ends a pair of worm bearings 30, a pair of worm bearing flanges 32, and a pair of oil seals 34 in coaxially spaced relation to rotationally support an actuator input shaft 36 on which is supported fixedly a threaded worm 38 in meshing engagement with the exterior threads 40 of the worm gear 24. In this manner, driven rotation of the actuator input shaft 36 causes the integral worm 38 to drive the worm gear 24 and, in turn, to drive reciprocation of the lifting screw 22. A portion of the actuator input shaft 36 projects outwardly from the housing shell 18 for connection with a drive source, which can be facilitated by providing a keyway 42 in the projecting portion of the input shaft 36 to receive a key 44 for connection with a matable driving member.

As shown in FIG. 3, the conventional speed changer unit 12 comprises a rectangular parallelepiped changer housing 46 formed with a first throughbore 48 extending between opposite side faces 50 and a second throughbore 52 extending perpendicularly thereto between opposite end faces 54. The first throughbore 48 supports at its opposite ends a pair of output flanges assemblies 55 comprising a pair of output flanges 56, a pair of output shaft bearings 58, and a pair of oil seals 60 in coaxially spaced relation to rotationally support a speed changer output shaft 62. A threaded annular worm gear 64 is fixedly attached via a key 66 to the changer output shaft 62 intermediate the output flange assemblies 55. The second throughbore 52 similarly supports at one end a drive mounting flange 68 and at the other end a worm flange assembly 70 comprising a worm flange 72, a worm bearing 74, and a worm oil seal (not shown) in coaxially spaced relation to rotationally support a threaded worm 76 in meshing engagement with the exterior threads 78 of the worm gear 64. In this manner, driven rotation of the worm 76 via a motor or other drive mounted to the flange 68 drives the worm gear 64 and, in turn rotates the changer output shaft 62. A portion of the changer output shaft 62 projects outwardly from the changer housing 46 for connection with a driven unit, which can be facilitated by providing a keyway 80 in the projecting portion of the changer output shaft 62 to receive a key 82.

As previously indicated, such mechanical actuator units 10 and speed changer units 12 are conventionally available from differing manufacturers, but conventionally these devices are not designed and engineered to mate with one another absent structural modification to the mechanical actuator unit 10, or speed changer unit 12, usually both. As persons skilled in the art will recognize and understand, it will be suitable in some applications of the conventional mechanical actuator unit 10 to couple a reversible drive motor directly to the actuator input shaft 36 for driving reciprocation of the lifting screw 22. In many applications, however, some form of speed-change transmission, such as the conventional speed changer unit 12, will be desirable to transmit the driving force from a reversible drive motor to the actuator input shaft 36. However, as already indicated above, the conventional speed changer unit 12 and the mechanical actuator unit 10 are not capable, without modification, of being coupled directly together for this purpose.

Also shown in FIGS. 2 and 3 are the replacement components that are used to modify a conventional mechanical actuator unit 10 for combination with a conventional speed changer unit 12. An extended length actuator input shaft 84 replaces the normal input shaft 36 of the conventional mechanical actuator unit 10. Like the input shaft 36, the elongated input shaft 84 may be formed with a keyway 86 for receiving an elongated key 88. Similarly, the conventional speed changer unit 12 is modified by installation of a hollow quill-type output shaft 90 formed with an interior axial keyway 92. The quill shaft 90 and its keyway 92 are selected to mate with the elongated input shaft 84 and its key 88, with the extended length actuator input shaft 84 being selected to extend fully through the quill shaft 90. Additionally, the actuator worm bearing flange 32 of the conventional mechanical actuator unit 10 is removed and replaced with an enlarged reducer mounting flange 94 sized to accommodate mounting to the output flange 56 of the speed changer unit 12.

Thus, as shown in FIG. 1, when the conventional mechanical actuator unit 10 is combined with the conventional speed changer unit 12, the elongated input shaft 84, is inserted coaxially into the quill-type changer output shaft 90 of the speed changer unit 12 and is coupled integrally thereto by fitting the elongated key 88 into the mating keyways 86 and 92. As a final connection means, the output flange 56 of the speed changer unit 12 facing the mechanical actuator unit 10 is bolted to the enlarged mounting flange 94 of the mechanical actuator unit 10.

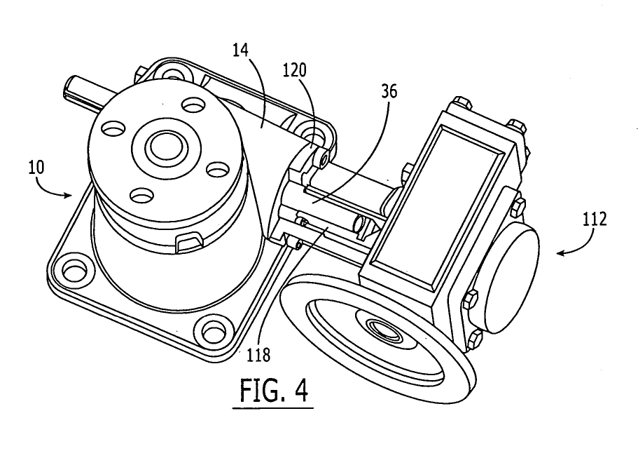

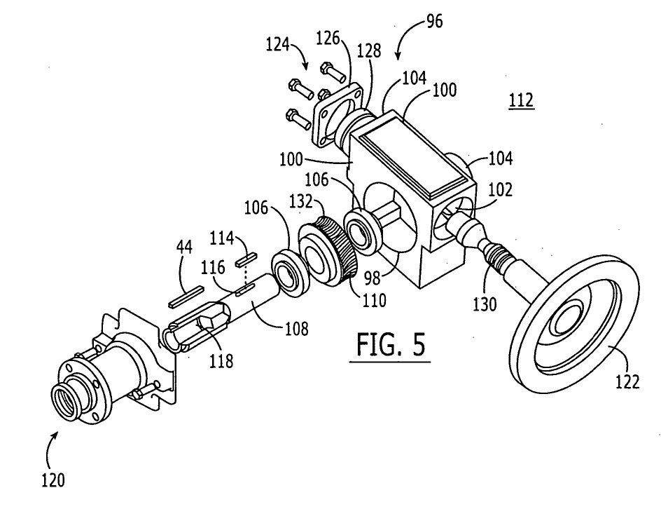

The present invention provides an improved speed changer unit 112, which facilitates the mating of the conventional, unmodified mechanical actuator unit 10 with the improved speed changer unit 112. Referring now to FIGS. 4 and 5, the improved combination of the mechanical actuator unit 10 and the improved speed changer unit 112, in accordance with the present invention, is shown in partially cut-away perspective in FIG. 4. FIG. 5 is an exploded perspective view of the improved speed changer unit 112 of the present invention.

As shown in FIG. 5, the improved speed changer unit 112 comprises a rectangular parallelepiped changer housing 96 formed with a first throughbore 98 extending between opposite side faces 100 and a second throughbore 102 extending perpendicularly thereto between opposite end faces 104. The first throughbore 98 is fitted with two coaxially spaced annular load bearings 106 which centrally receive and support a changer output shaft 108 for driven rotation. An exteriorly threaded annular worm gear 110 is affixed coaxially about the changer output shaft 108 between and coaxial with the load bearings 106 via a key 114 fitted in keyway 116 in the output shaft 108. The output shaft 108 is formed at one end with a blind axial bore 118 adapted for receiving the input shaft 36 of the mechanical actuator unit 10. An output flange assembly 120 is affixed to the side face 100 of the changer housing 96 surrounding the output shaft 108, the flange assembly 120 being configured to attach directly to the housing 14 of the conventional unmodified actuator unit 10. The second throughbore 102 supports at one end a drive mounting flange 122 and at the other end a worm flange assembly 124 comprising a worm flange 126, a worm bearing 128, and a worm oil seal (not shown) in coaxially spaced relation to rotationally support a threaded worm 130 in meshing engagement with the exterior threads 132 of the worm gear 110.

Thus, as shown in FIG. 4, the improved speed changer unit 112 may be readily coupled directly with a substantially unmodified conventional mechanical actuator unit 10. The blind hole 118 of the speed changer output shaft 108 receives the actuator input shaft 36 of the conventional mechanical actuator unit 10 and is coupled fixedly thereto by the key 44. The normal flange 32 of the actuator unit 10 is removed, whereby the matching output flange assembly 120 of the improved speed changer 112, which is positioned in surrounding relation to the changer output shaft 108, may be bolted directly to the actuator unit housing 14.

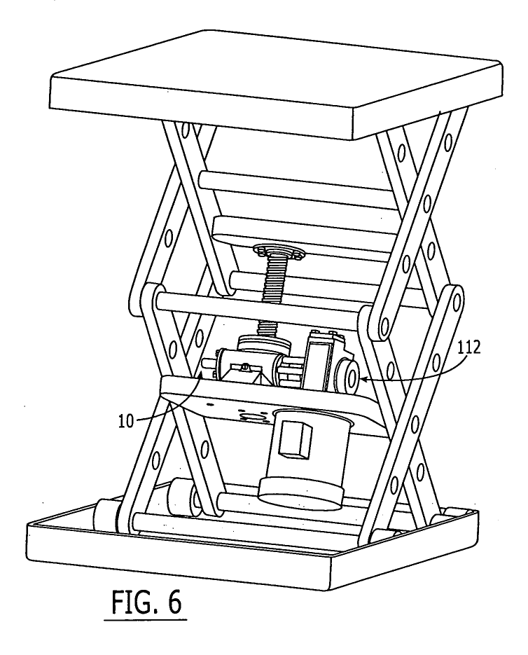

FIG. 6 is a perspective view of the coupled mechanical actuator unit 10 and improved speed changer unit 112 in a representative installation for use in opening and closing the scissors mechanism of a so-called lift table, which is generally used to raise material, especially heavy material, from one level to another. Lift tables with actuator/speed changer combinations may be found many industries, e.g., the automotive industry for transfer of automobiles, the transportation industry for cargo loading, and the manufacturing industry for numerous purposes. Of course, it will be readily appreciated that the combined actuator and speed changer assembly 10, 112 of the present invention will have numerous other potential applications.

Advantageously, the present invention will alleviate the requirement in conventional actuator/speed changer combinations that both units be modified in order for them to be combined for use. The present invention in comparison to conventional actuator/changer combinations is easier, more efficient, and cheaper to use. Those using actuator/changer combinations will no longer need to incur the expense of replacing existing components with replacement components for combination.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended to be construed to limit the present invention or otherwise to exclude any such other embodiments, adaptations, variations, modifications and equivalent arrangements, the present invention being limited only by the claims appended hereto and the equivalents thereof.

What is claimed is:

1. In combination, a mechanical actuator and a speed changer coupled directly to one another, wherein:
(a) the mechanical actuator comprises:
(i) an actuator housing;
(ii) an actuator output shaft supported within the actuator housing for linear reciprocation inwardly and outwardly therefrom;
(iii) an actuator input shaft supported rotationally within the actuator housing with an end of the actuator input shaft projecting outwardly from the actuator housing, and
(iv) a mechanical arrangement within the actuator housing for translating rotational motion of the actuator input shaft into linear motion of the actuator output shaft; and
(b) the speed changer comprises:
(i) a changer housing having an output flange abutted with and affixed directly to the actuator housing in surrounding relation to the actuator input shaft; and
(ii) a changer output shaft supported rotationally within the output flange, the changer output shaft being formed with a blind hole in which the actuator input shaft is received for integral driving rotation of the actuator input shaft by the changer output shaft.

2. The combination of a mechanical actuator and a speed changer according to claim 1, wherein the mechanical arrangement of the mechanical actuator comprises a worm gear coaxial with the actuator output shaft and a worm coaxial with the actuator input shaft and disposed in meshing engagement with the worm gear.

3. The combination of a mechanical actuator and a speed changer according to claim 1, wherein the speed changer is a torque multiplier.

4. The combination of a mechanical actuator and a speed changer according to claim 1, wherein the speed changer is a speed reducer.

5. The combination of a mechanical actuator and a speed changer according to claim 1, wherein one of the actuator input shaft and the changer output shaft is formed with an integral key an the other thereof is formed with a mating keyway for receiving the key.

6. In combination with a conventional mechanical actuator of the type having an actuator housing, an actuator output shaft supported within the actuator housing for linear reciprocation inwardly and outwardly therefrom, an actuator input shaft supported rotationally within the actuator housing with an end of the actuator input shaft projecting outwardly from the actuator housing, and a mechanical arrangement within the actuator housing for translating rotational motion of the actuator input shaft into linear motion of the actuator output shaft, an improved speed changer comprising:
(a) a changer housing having an output flange abutted with and affixed directly to the actuator housing in surrounding relation to the actuator input shaft; and
(b) a changer output shaft supported rotationally within the output flange, the changer output shaft being formed with a blind hole in which the actuator input shaft is received for integral driving rotation of the actuator input shaft by the changer output shaft.

7. The combination of a conventional mechanical actuator and an improved speed changer according to claim 6, wherein the mechanical arrangement of the mechanical actuator comprises a worm gear coaxial with the actuator output shaft and a worm coaxial with the actuator input shaft and disposed in making engagement with the worm gear.

8. The combination of a conventional mechanical actuator and an improved speed changer according to claim 6, wherein the speed changer is a torque multiplier.

9. The combination of a conventional mechanical actuator and an improved speed changer according to claim 6, wherein the speed changer is a speed reducer.

10. The combination of a mechanical actuator and a speed changer according to claim 6, wherein one of the actuator input shaft and the changer output shaft is formed with an integral key an the other thereof is formed with a mating keyway for receiving the key.
